(19) United States
(12) Patent Application Publication
(10) Pub. No.: US 2026/0288709 A1
(43) Pub. Date: Sep. 24, 2026

(54) A SYSTEM FOR PRESCRIPTIVE AND PROTECTED PROMPT ENGINEERING AND A METHOD THEREOF

(71) Applicant: PRIVASAPIEN TECHNOLOGIES PRIVATE LIMITED, Bengaluru (IN)

(72) Inventor: Abilash Soundararajan, Bangalore (IN)

(21) Appl. No.: 19/473,576

(22) PCT Filed: Apr. 8, 2024
(86) PCT No.: PCT/IB2024/053433

§ 371 Date: Oct. 8, 2025

(30) Foreign Application Priority Data
Apr. 10, 2023 (IN) 202341026640

(51) Int. Cl. G06F 16/2452; G06F 16/332; H04L 9/40

(52) U.S. Cl. CPC G06F 16/2452; G06F 16/3322; H04L 63/1433

(57) ABSTRACT

A system 100 for prescriptive and protected prompt engineering for a generative artificial intelligence is disclosed. The system includes processing subsystem 108 which includes a user requirement input module 114 to receive one or more first queries prompt from a user, an interactive query module 116 suggests a plurality of second queries prompt to the user, a context gathering module 120 collects information related to a context of the input query, an objective gathering module 122 collect objectives of the first input queries, an assumption validation module 124 validates the selected option for the prompts, a prompt creation module 126, an expected utility validation module 128 validates the utility of the prompt, a risk assessment and mitigation module 130 understands risk of the input prompts and mitigation related to the prompts, and a prompt translation module 132 translates the selected prompt based on user's language preference.

### EARLIEST PRIORITY DATE

This Application claims priority from a provisional patent application filed in India having Patent Application No. 202341026640, filed on Apr. 10, 2023, and titled “SYSTEM AND METHOD FOR PRESCRIPTIVE AND PROTECTED PROMPT ENGINEERING FOR GENERATIVE AI” and PCT application filed having Patent Application No. PCT/IB2024/053433 filed on 8 Apr. 2024, and titled “A SYSTEM FOR PRESCRIPTIVE AND PROTECTED PROMPT ENGINEERING AND A METHOD THEREOF”.

### FIELD OF INVENTION

Embodiments of a present disclosure relate to artificial intelligence governance platform and more particularly to a system for prescriptive and protected prompt engineering for a generative artificial intelligence and a method thereof.

### BACKGROUND

Prompt engineering for generative artificial intelligence (AI) involves crafting specific instructions or prompts to guide the AI model in generating desired outputs. In the case of generative AI, the prompt engineering is crucial for steering the AI model to produce content that aligns with user requirement. Although, the prompt engineering is a powerful tool for guiding generative AI models to produce desired outputs, there are several drawbacks and challenges associated with this approach.

The existing, generative AI models may struggle to deviate from the guidance provided by the prompts, limiting their ability to generate diverse or unexpected content. This can result in outputs that feel formulaic or lack spontaneity. Also, current prompt engineering techniques finds it challenging to convey certain concepts or nuances effectively through only prompts. Communicating complex instructions or guiding the AI model to capture subtle nuances of human language and behaviour can be difficult. Most of the time people have the challenge of not being able to express their requirement clearly in words. Further, the prompts may also leak sensitive information.

Hence, there is a need for a system for prescriptive and protected prompt engineering for a generative artificial intelligence and a method thereof which addresses the aforementioned issues.

### OBJECTIVE OF THE INVENTION

An objective of the present invention is to provide a system perspective and protected prompt engineering for generative artificial intelligence.

Another objective of the present invention is to provide a multilinguistic interactive prompt.

Yet, another objective of present invention is to provide a prescriptive and protected prompt engineering for generative AI, which understands the objective, assumptions, context of a query asked by a user.

Further, an objective of the present invention is to identify risk, provide solutions for the risk, and recommends one or more queries with varying levels of identified risk.

Furthermore, an objective of the present invention is to provide a privacy protection to the data inputted by the user.

### BRIEF DESCRIPTION

In accordance with one embodiment of the disclosure, a system for prescriptive and protected prompt engineering for a generative artificial intelligence is provided. The system includes at least one processor and at least one memory. The at least one processor is in communication with a client processor. The at least one memory includes a set of program instructions in the form of a processing subsystem, configured to be executed by the at least one processor. The processing subsystem is hosted on a server and configured to execute on a network to control bidirectional communications among a plurality of modules. The plurality of modules includes a user requirement input module, an interactive query module, a context gathering module, an objective gathering module, an assumption validation module, a prompt creation module, an expected utility validation module, a risk assessment and mitigation module, a prompt translation module, and a feedback capture module. The user requirement input module is configured to receive one or more first queries prompt from a user as a user requirement. The interactive query module is operatively connected to the user requirement input module. The interactive query module is also configured to suggest one or more second queries prompt to the user based on the user requirement to generate one or more prompts to allow the user to select and edit the one or more prompts. The context gathering module is operatively coupled to the interactive query module and configured to collect an information related to a context of the input query. The objective gathering module is operatively connected to the user requirement input module, wherein the objective collection module is configured to collect a plurality of objectives of the one or more first input queries. The assumption validation module is operatively coupled to the interactive query module. The assumption validation module is configured to validate the selected option of the plurality of options for the one or more prompts based on a plurality of predefined utility validation rules. The prompt creation module is operatively coupled to the interactive query module, wherein the prompt creation module is configured to generate the one or more holistically optimized and privacy preserved prompts by consideration of output of context gathering module and object gathering module. The expected utility validation module is operatively coupled to the interactive query module. The expected utility validation module is configured to quantify the utility of the one or more generated optimized prompt with minimal risk as optimized by risk assessment and mitigation module and select the most optimal prompt. The risk assessment and mitigation module is operatively coupled with the input module and configured to understand the risk one or more input prompt related to a sensitive information and mitigation related to the one or more prompts for providing a holistically privacy optimized synthetic prompt generated with minimal identified risk. The prompt translation module is operatively coupled to the prompt creation module. The prompt translation module is configured to translate the selected prompt by the interactive query module. The feedback capture module operatively coupled to the risk assessment and mitigation module, wherein the feedback capture module is configured to allow the user to provide feedback and captures the feedback provided by the user for providing further prompt recommendations.

In accordance with another embodiment a method for conducting a prescriptive and protected prompt engineering for a generative artificial intelligence is provided. The method includes receiving, by a user requirement module of a processing subsystem, first queries prompt from a user as a user requirement. The method also includes suggesting, by an interactive query module of the processing subsystem, one or more second queries prompt to the user based on the user requirement to generate one or more prompts to allow the user to select and edit the one or more prompts. Further, the method includes collecting, by a context gathering module of the processing subsystem, an information related to a context of the input query. Furthermore, the method includes collecting, by an objective collection module of the processing subsystem, a plurality of objectives of the one or more first input queries. Furthermore, the method includes validating, by an assumption validation module of the processing subsystem, the selected prompts based on a plurality of predefined utility validation rules. Furthermore, the method includes generating, by a prompt creation module of the processing subsystem, the one or more holistically optimized and privacy preserved prompts by consideration of output of context gathering module and object gathering module. Moreover, the method includes quantifying, an expected utility validation module of the processing subsystem, the utility of the one or more generated optimized prompt with minimal risk as optimized by risk assessment and mitigation module and select the most optimal prompt. Moreover, the method includes understanding, a risk assessment and mitigation module of the processing subsystem, the risk one or more input prompt related to a sensitive information and mitigation related to the one or more prompts for providing a holistically privacy optimized synthetic prompt generated with minimal identified risk. Moreover, the method includes translating, by a prompt translation module of the processing subsystem, the selected prompt by the interactive query module. Moreover, the method includes allowing, by a feedback capture module the processing subsystem, the user to provide feedback and captures the feedback provided by the user for providing further prompt recommendations.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for perspective and protective prompt engineering for generative artificial intelligence in accordance with an embodiment of the present disclosure;

FIG. 2 is a block diagram of a computer or a server for the computer-implemented system perspective and protective prompt engineering for generative artificial intelligence in accordance with an embodiment of the present disclosure; and

FIG. 3 is a flowchart representing steps involved in a method for conducting a computer-implemented system for perspective and protective prompt engineering for generative artificial intelligence in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for prescriptive and protected prompt engineering for a generative artificial intelligence is provided. The system includes at least one processor and at least one memory. The at least one processor is in communication with a client processor. The at least one memory includes a set of program instructions in the form of a processing subsystem, configured to be executed by the at least one processor. The processing subsystem is hosted on a server and configured to execute on a network to control bidirectional communications among a plurality of modules. The plurality of modules includes a user requirement input module, an interactive query module, a context gathering module, an objective gathering module, an assumption validation module, a prompt creation module, an expected utility validation module, a risk assessment and mitigation module and a prompt translation module. The user requirement input module is configured to receive one or more first queries prompt from a user as a user requirement. The interactive query module is operatively connected to the user requirement input module. The interactive query module is also configured to suggest one or more second queries prompt to the user based on the user requirement to generate one or more prompts to allow the user to select and edit the one or more prompts. The context gathering module is operatively coupled to the interactive query module and configured to collect an information related to a context of the input query. The objective gathering module is operatively connected to the user requirement input module, wherein the objective collection module is configured to collect a plurality of objectives of the one or more first input queries. The assumption validation module is operatively coupled to the interactive query module. The assumption validation module is configured to validate the selected option of the plurality of options for the one or more prompts based on a plurality of predefined utility validation rules. The prompt creation module is operatively coupled to the interactive query module, wherein the prompt creation module is configured to generate the one or more holistically optimized and privacy preserved prompts by consideration of output of context gathering module and object gathering module. The expected utility validation module is operatively coupled to the interactive query module. The expected utility validation module is configured to quantify the utility of the one or more generated optimized prompt with minimal risk as optimized by risk assessment and mitigation module and select the most optimal prompt. The risk assessment and mitigation module is operatively coupled with the input module and configured to understand the risk one or more input prompt related to a sensitive information and mitigation related to the one or more prompts for providing a holistically privacy optimized synthetic prompt generated with minimal identified risk. The prompt translation module is operatively coupled to the prompt creation module. The prompt translation module is configured to translate the selected prompt by the interactive query module. The feedback capture module operatively coupled to the prompt risk assessment and mitigation module, wherein the feedback capture module is configured to allow the user to provide feedback and captures the feedback provided by the user for providing further prompt recommendations.

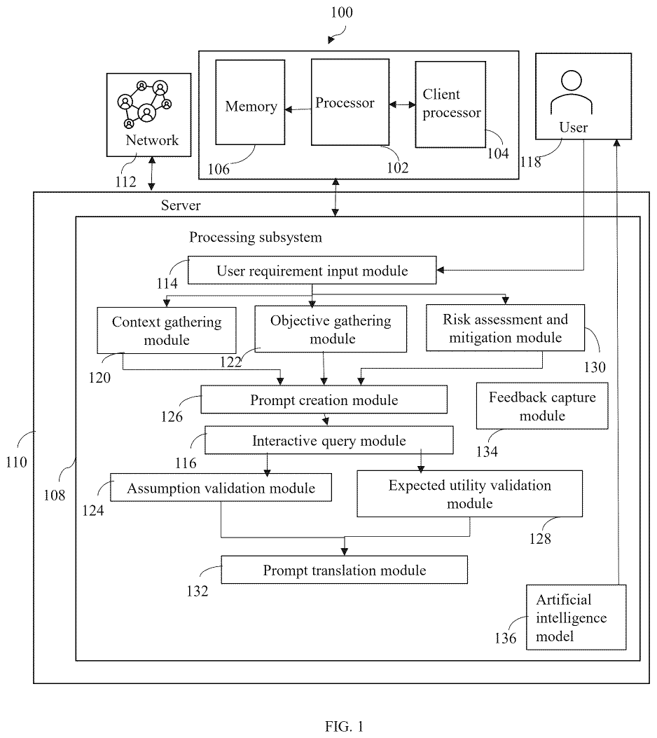

FIG. 1 is a block diagram representing a system 100 for prescriptive and protected prompt engineering for a generative artificial intelligence in accordance with an embodiment of the present disclosure. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The computer-implemented system 100 includes at least one processor 102 and a memory 106. The at least one processor 102 is in communication with a client processor 104. The at least one processor 102 generally refers to a computational unit or central processing unit (CPU) responsible for executing instructions in a computer system. The phrase “in communication with a client processor” implies that there is a relationship or interaction between at least one processor and a specific type of processor referred to as a “client processor.” Here, the term “client processor” refer to a processor that initiates requests or tasks and interacts with another processor (which may be a server processor) to fulfil those requests.

The memory 106 includes a set of instructions in the form of a processing subsystem 108, configured to be executed by the at least one processor 102. The processing subsystem 108 is hosted on a server 110 and configured to execute on a network 112 to control bidirectional communications among a plurality of modules. In one embodiment, the server 110 may include a cloud server. In another embodiment, the server 110 may include a local server. In one embodiment, the network 112 may include a wired network such as a local area network (LAN). In another embodiment, the network 112 may include a wireless network such as Wi-Fi, Bluetooth, Zigbee, near-field communication (NFC), infrared communication (RFID), or the like.

The plurality of modules includes a user requirement input module 114, an interactive query module 116, a context gathering module 120, an objective gathering module 122, an assumption validation module 124, a prompt creation module 126, an expected utility validation module 128, a risk assessment and mitigation module 130, a prompt translation module 132 and a feedback capture module 134. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The user requirement input module 114 is configured to receive one or more first queries prompt from a user 118 as a user requirement. In one embodiment, the one or more input queries prompt may include at least one of an image, a text file, an audio file, and a video file. In one embodiment, the plurality of text files includes plain text (.txt), comma-separated values (.csv), JSON (JavaScript Object Notation) files, XML (extensible Markup Language) files, rich text format (.rtf), HTML (Hypertext Markup Language) files, log files, and the like. The user requirement input module 114 is designed to handle input prompts that anticipate interactions with a plurality of artificial intelligence models 136. These AI models may be within the system. The user requirement input module 114 is responsible for receiving requirement input prompts as well as collects the corresponding input responses. As used herein, the ‘input responses’ refer to the user's replies or feedback to the prompts received. The user requirement input module 114 is versatile in its data sources, as it can collect input prompts and responses from various channels, including users, or user applications, and the like.

The interactive query module 116 is operatively connected to the user requirement input module 114. The interactive query module 116 is configured to suggest one or more second queries prompt to the user 118 based on the user requirement to generate one or more prompt is to allow the user 118 to select and edit the one or more prompts. In one embodiment, the interactive query module 116 provides a plurality of queries for interaction with user 118 to provide information and assistance to the user 118.

The context gathering module 120 is operatively coupled to the interactive query module 116 and configured to collect an information related to a context of the input query. In one embodiment, the processing subsystem includes 108 an artificial intelligence model 136 operatively coupled with the context gathering module 120. The artificial intelligence model 136 is trained based on the collected context and provides the plurality of prompt recommendation along with a prompt recommendation for selecting one or more foremost prompt by the user 118. In one embodiment, the plurality of prompt recommendations are based on the information collected, wherein the plurality of recommendation includes a grammar change, time change, a change in financial information, and the like. In one embodiment the training of AI model refers to a process in which the context gathering module 120 is exposed to the context of the user input based on the interaction with the user 118. During this phase, the AI model learns patterns and features associated with the information related to the query of the user for example, if user 118 is asking about hotels, then the AI model learns about the user's food preferences and choices.

The objective gathering module 122 is operatively connected to the user requirement input module 114. The objective collection module 122 is configured to collect a plurality of objectives of the one or more first input queries.

In one embodiment, the objective gathering module 122 is configured to collect a plurality of objectives from the prompt, user role, configured usage and chain of thoughts based on which the objective of creating an optimized synthetic prompt is created.

The assumption validation module 124 is operatively coupled to the interactive query module 116, wherein the assumption validation module 124 is configured to validate the selected option of the plurality of options for the one or more prompts based on a plurality of predefined utility validation rules. In one embodiment, the assumption validation also includes verification the validation of various assumptions of the output response to be given by the system based on the user query. These assumptions may range from data quality and distribution to the AI model assumptions and user input.

The prompt creation module 126 is operatively coupled to the interactive query module 116. The prompt creation module 126 is configured to generate the one or more holistically optimized and privacy preserved prompts by consideration of output of context gathering module 120 and objective gathering module 122. In one embodiment, a prompt creation module 126 is designed to provide one or more than one optimized prompt against the user input prompt such that user can get helpful and accurate results from the AI based models like ChatGPT-4, Daily. The prompt creation model also take care of the privacy risk in the newly generated prompt. Consider a non-limiting example:
User: Can you help me write an email to Rahul from the finance department at Privasapien, requesting an update on the financial year from 4 Jan. 2020 to 31 Mar. 2021?
AI [Optimized query]: Could you assist me in drafting an email to X, a colleague of Y organization finance department? I would like to request an update regarding the fiscal year spanning from Jan. 5, 2010, to Jul. 31, 2011.
Context: Writing a mail to X person of Y organization to ask finance report of financial year 2020-2021
Objective: Drafting a mail
Risk: Persona risk [because Rahul(name) and Privasapien (organization) occurred], DateTime Risk [because Jan. 5, 2010, to Jul. 31, 2011, occurred]

Further, the prompt creation module 126 helps in holistically optimized and privacy preserved prompts by rewriting the complete prompt based on the context gathering module 120, user role, configured usage, chain of thoughts and historic behaviour.

The expected utility validation module 128 is operatively coupled to the interactive query module 116, wherein the expected utility validation module 128 is configured to quantify the utility of the one or more generated optimized prompt with minimal risk as optimized by risk assessment and mitigation module 130 and select the most optimal prompt. In one embodiment, the utility validation refers to a process of assessing and confirming usefulness, effectiveness, and value of the user selected option for its intended purpose. The utility validation also involves evaluating how well the AI model identifies context, objective, and expected utility of the user's query and whether it provides practical benefits or value to users.

In one embodiment, the expected utility validation module 128 is configured to involve human in the loop based on configurable threshold parameters based on prompts'utility and level of risk identified, while selecting the most optimal prompt.

The risk assessment and mitigation module 130 is operatively coupled with the user requirement input module 114. The risk assessment and mitigation module 130 is configured to understand the risk of one or more input prompt in relation to a sensitive information and mitigation related to the one or more prompts for providing a holistically privacy optimized synthetic prompt generated with minimal identified risk. In one embodiment, the AI model 136 are designed to analyse and interpret the user requirement to various types of risks related to the data. In one embodiment, the risk assessment and mitigation module 130 is configured to assist various entities in identifying a variety of risks. These include risks related to compliance with laws and regulations, user-specific risks which are tailored to individual user preferences or requirements, and the like.

In one embodiment, the processing subsystem 108 includes the feedback capture module 134 operatively coupled to the risk assessment and mitigation module 130. The feedback capture module 134 is configured to allow the user 118 to provide feedback and captures the feedback provided by the user 118 for providing further prompt recommendations. This feedback is crucial for subsequent stages, especially for risk identification. In one embodiment, the feedback capturing module 134 involves collecting insights and corrections provided by users to refine the risk assessment and mitigation module 130. By collecting and incorporating the feedback, the feedback capturing module 134 contributes to the gradual improvement of the system's performance in identifying risks over time. This iterative learning process ensures continuous enhancement. The feedback capturing module 134 includes valuable insights and corrections provided by users in the learning process. This helps refine the AI model for more accurate risk identification.

The prompt translation module 132 is operatively coupled to the prompt creation module 126. The prompt translation module 132 is configured to translate the selected prompt by the interactive query module 116 based on a language preference of the user 118. In one embodiment, the prompt translation module 132 leverages advanced artificial intelligence techniques, including Natural Language Processing (NLP). NLP enables the AI model to understand and process the user input language, allowing it to identify and categorize privacy risks within input data, such as input prompts or information flow. This includes information that can be used to identify an individual, such as names, unique identities, locations, personal quasi-identifiers, and statistical data outliers. In one embodiment, the prompt translation module 132 translates a prompt to a different language based on user preference or administrator preference or downstream model performance for various languages.

Consider a scenario, where a registered user X inputs a query asking for “a hospital near XYZ colony” in the user requirement input module 114. The interactive query module 116 interacts with the user X asking a multiple questions to the user such as “which age group needs the hospital”, “which specialist is need”, and the like. The context gathering module 120 collects all the information based on the answers to the questions asked by the interactive query module 116. After gathering the context of the artificial intelligence model 136 provides the plurality of prompt recommendations along with a prompt recommendation for selecting one or more foremost prompt by the user 118. The artificial intelligence model 136 is trained based on the context of the input query. The objective of the user's query is analysed and gathered such as “urgency of finding the hospital.” Based on the recommendation, the ser X may select an option of the hospital and the assumption validation module 124 validate the selected hospital name for its use and expected utility. The expected utility is found out by generative AI. The expected utility considered by analysing if the recommended hospital is nearby the user's location, or if the specialised doctors are available in the hospital, and the like. If the user 118 provides any sensitive information such as “user phone number” then the risk assessment and mitigation module 130 identifies the risk and provides a holistically privacy optimized synthetic prompt generated with minimal identified risk. If the user wants to communicate in his/her local language, then the prompt translation module 132 changes the language based on the user language preference. An exemplary depiction of a communication between the system 100 and user X is:
User X: Hospitals near XYZ colony
System: what is a landmark near XYZ colony?
User X: A central mall
System: For which age group the hospital is required?
User X: 60 years and above
System: Do you need any specialist?
User X: yes, a heart specialist
System: Here are few recommendations:
   P heart clinic,
   Q hospital, and
   R Multi speciality hospital

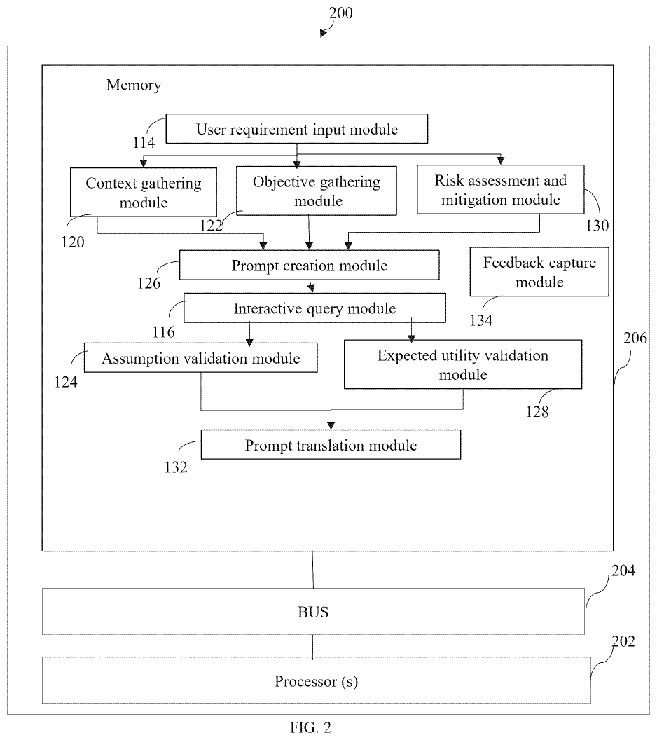

FIG. 2 is a block diagram 200 of a computer or a server for the computer-implemented for multi modal aggregation and governance platform in a responsible artificial intelligence in accordance with an embodiment of the present disclosure. The server includes a processor(s) 202, and memory 202 is operatively coupled to the bus 204.

The processor(s) 204 as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 204 as used herein refers to be internal memory channels or computer network that is used to connect computer components and transfer data between them. The bus 204 includes a serial bus or a parallel bus, wherein the serial bus transmits data in a bit-serial format and the parallel bus transmits data across multiple wires. The bus 204 as used herein, may include but not limited to, a system bus, an internal bus, an external bus, an expansion bus, a frontside bus, a backside bus, and the like.

The memory 206 includes a plurality of subsystems and a plurality of modules stored in the form of an executable program which instructs the processor to the computer-implemented system illustrated in FIG. 1. The memory 206 is substantially similar for the system for perspective and protected prompt engineering for generative artificial intelligence of FIG. 1. The memory 206 has submodules: a user requirement input module 114, an interactive query module 116, a context gathering module 120, an objective gathering module 122, an assumption validation module 124, a prompt creation module 126, an expected utility validation module 128, a risk assessment and mitigation module 130, a prompt translation module 132, and a feedback capture module 134.

The user requirement input module 114 is configured to receive one or more first queries prompt from a user 118 as a user requirement.

The interactive query module 116 is operatively connected to the user requirement input module 114. The interactive query module 116 is configured to suggest one or more second queries prompt to the user 118 based on the user requirement to generate one or more prompt is to allow the user 118 to select and edit the one or more prompts.

The context gathering module 120 is operatively coupled to the interactive query module 116 and configured to collect an information related to a context of the input query. In one embodiment, the processing subsystem 108 includes an artificial intelligence model 136 operatively coupled with the context gathering module 120. The artificial intelligence model 136 is trained based on the context and provides the plurality of prompt recommendation along with a prompt recommendation for selecting one or more foremost prompt by the user 118. Training of AI model 136 refers to the process in which the context gathering module 120 is exposed to relevant datasets containing examples of contexts and objectives of the user query.

The objective gathering module 122 is operatively connected to the user requirement input module 114. The objective collection module 122 is configured to collect a plurality of objectives of the one or more first input queries. In one embodiment, the objective gathering module 122 is configured to gather information related to user's objective to search for the query. For example, if the user enters “food” then after asking a plurality of queries such as “are you vegetarian?”, “Which type of food do you like?”, the objective gathering module 122 analyses and collects the objective of the user query. In one embodiment, the collected objective is used for future recommendations to the user and also uses to train the AI model.

In one embodiment, the objective gathering module 122 is configured to collect a plurality of objectives from the prompt, user role, configured usage and chain of thoughts based on which the objective of creating an optimized synthetic prompt is created.

The assumption validation module 124 is operatively coupled to the interactive query module 116, wherein the assumption validation module 124 is configured to validate the selected option of the plurality of options for the one or more prompts based on a plurality of predefined utility validation rules.

The prompt creation module 126 is operatively coupled to the interactive query module 116. The prompt creation module 126 is configured to generate the one or more holistically optimized and privacy preserved prompts by consideration of output of the context gathering module 120 and objective gathering module 122. In one embodiment, the prompt creation module 126 helps in holistically optimized and privacy preserved prompts by rewriting the complete prompt based on the context gathering module 120, user role, configured usage, chain of thoughts and historic behaviour.

The expected utility validation module 128 is operatively coupled to the interactive query module 116, wherein the expected utility validation module 128 is configured to quantify the utility of the one or more generated optimized prompt with minimal risk as optimized by risk assessment and mitigation module 130 and select the most optimal prompt. In one embodiment, the expected utility validation module 128 involves human in the loop based on configurable threshold parameters based on prompts'utility and level of risk identified, while selecting the most optimal prompt.

The risk assessment and mitigation module 130 is operatively coupled with the user requirement input module 114. The risk assessment and mitigation module 130 is configured to understand the risk of one or more input prompt in relation to a sensitive information and mitigation related to the one or more prompts for providing a holistically privacy optimized synthetic prompt generated with minimal identified risk.

The prompt translation module 132 is operatively coupled to the prompt creation module 126. The prompt translation module 132 is configured to translate the selected prompt by the interactive query module based on a language preference of the user 118. In one embodiment, the prompt translation module 132 translates a prompt to a different language based on user preference or administrator preference or downstream model performance for various languages.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) 202.

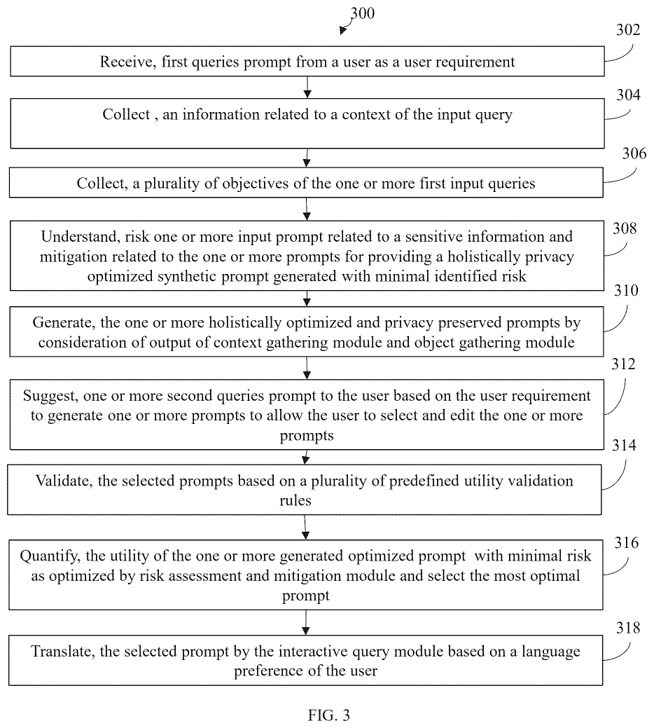

FIG. 3 is a flowchart representing steps involved in a method 300 for conducting a perspective and protected prompt engineering for generative artificial intelligence in accordance with an embodiment of the present disclosure. The method creates a completely new optimized prompt for the generative artificial intelligence.

The method 300 includes receiving, by a user requirement module of a processing subsystem, first queries prompt from a user as a user requirement in step (302).

The method 300 also includes suggesting, by an interactive query module of the processing subsystem, one or more second queries prompt to the user based on the user requirement to generate one or more prompts to allow the user to select and edit the one or more prompts in step 304.

Further, the method 300 includes collecting, by a context gathering module of the processing subsystem, an information related to a context of the input query in step 306. The method 300 also includes providing, a plurality of recommendations based on the information collected, wherein the plurality of recommendation comprises at least one of a grammar change, time change, and a change in financial information.

Furthermore, the method 300 includes collecting, by an objective collection module of the processing subsystem, a plurality of objectives of the one or more first input queries in step 308. The method 300 also includes training, an artificial intelligence model based on the context and provides the plurality of prompt recommendation along with a prompt recommendation for selecting one or more foremost prompt by the user.

In one embodiment, the method 300 includes collecting, by the objective gathering module, a plurality of objectives from the prompt, user role, configured usage and chain of thoughts based on which the objective of creating an optimized synthetic prompt is created. Moreover, the method 300 includes validating, by an assumption validation module of the processing subsystem, the selected option of the plurality of options for the one or more prompts based on a plurality of predefined utility validation rules in step 310.

Moreover, the method 300 includes generating, by a prompt creation module of the processing subsystem, the one or more holistically optimized and privacy preserved prompts by consideration of output of context gathering module and object gathering module in step 312.

In one embodiment, the method 300 includes helping, by the prompt creation module, in holistically optimized and privacy preserved prompts by rewriting the complete prompt based on the context gathering module, user role, configured usage, chain of thoughts and historic behaviour.

Moreover, the method 300 includes generating, by an expected utility validation module of the processing subsystem, the one or more prompts by consideration of output of context gathering module and object gathering module in step 314.

In one embodiment, the method 300 includes involving human in the loop, by the expected utility validation module, based on configurable threshold parameters based on prompts'utility and level of risk identified, while selecting the most optimal prompt.

Moreover, the method 300 includes understanding, by a risk assessment and mitigation module of the processing subsystem, risk one or more input prompt related to a sensitive information and mitigation related to the one or more prompts for providing a holistically privacy optimized synthetic prompt generated with minimal identified risk in step 316. The method also includes allowing, by a feedback assessment and mitigation module of the processing subsystem, the user to provide feedback and captures the feedback provided by the user for providing further prompt recommendations.

Moreover, the method 300 includes translating, by a prompt translation module of the processing subsystem, the selected prompt by the interactive query module based on a language preference of the user in step 318.

In one embodiment, the method 300 includes translating, by the prompt translation module, a prompt to a different language based on user preference or administrator preference or downstream model performance for various languages.

Various embodiments of the present disclosure provides a system perspective and protected prompt engineering for generative artificial intelligence. The prompt translation module of the system provides a multilinguistic interactive prompt by translating the prompt selected by the user. The context gathering module, the objective gathering module, and the assumption validation module discloses in the present disclosure, provides accurate output to the user's query by understanding the objective, assumptions, context of a query asked by a user. The risk assessment and mitigation module disclosed in the present disclosure identifies risk in the input prompt by the user and provide solutions for a holistically privacy optimized synthetic prompt generated with minimal identified risk and recommends one or more queries with varying levels of identified risk.

Further, the risk assessment and mitigation module of the system also provide a privacy protection to the data inputted by the user. The feedback module of the system disclosed in the present disclosure allows the user to provide feedback and provide future prompt recommendation based on the user's feedback.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for prescriptive and protected prompt engineering for a generative artificial intelligence comprising:
at least one processor in communication with a client processor (104); and
characterised in that:
at least one memory comprises a set of program instructions in the form of a processing subsystem, configured to be executed by the at least one processor, wherein the processing subsystem is hosted on a server and configured to execute on a network to control bidirectional communications among a plurality of modules comprising:
a user requirement input module configured to receive one or more first queries prompt from a user as a user requirement;
a context gathering module operatively coupled to the user requirement input module and configured to collect an information related to a context of the input query;
an objective gathering module operatively connected to the user requirement input module, wherein the objective gathering module is configured to collect a plurality of objectives of the one or more first input queries;
a risk assessment and mitigation module operatively coupled with the user requirement input module and configured to understand risk of one or more input prompt in relation to a sensitive information and mitigation related to the one or more prompts for providing a holistically privacy optimized synthetic prompt generated with minimal identified risk;
a prompt creation module operatively coupled to the context gathering module, the objective gathering module, and the risk assessment and mitigation module, wherein the prompt creation module is configured to generate the one or more holistically optimized and privacy preserved prompts by consideration of output of context gathering module and objective gathering module;
an interactive query module operatively connected to the prompt creation module and configured to suggest a plurality of second queries prompt to the user based on the user requirement to generate one or more prompts to allow the user to select and edit the one or more prompts;
an assumption validation module operatively coupled to the interactive query module, wherein the assumption validation module is configured to validate the selected option of the plurality of options for the one or more prompts based on a plurality of predefined utility validation rules;
an expected utility validation module operatively coupled to the interactive query module, wherein the expected utility validation module is configured quantify the utility of the one or more generated optimized prompt with minimal risk as optimized by risk assessment and mitigation module and select the most optimal prompt; and
a prompt translation module operatively coupled to the assumption validation module and the expected utility validation module, wherein the prompt translation module is configured to translate the selected prompt by the interactive query module.

2. The system as claimed in claim 1, is configured to provide a plurality of recommendations based on the information collected, wherein the plurality of recommendation comprises at least one of a grammar change, time change, and a change in financial information.

3. The system as claimed in claim 1, wherein the processing subsystem comprises an artificial intelligence model operatively coupled with the context gathering module trained based on the context and provides the plurality of prompt recommendation along with a prompt recommendation for selecting one or more foremost prompt by the user.

4. The system as claimed in claim 1, wherein the processing subsystem comprises a feedback capture module operatively coupled to the interactive query module, wherein the feedback capture module is configured to allow the user to provide feedback and captures the feedback provided by the user for providing further prompt recommendations.

5. The system as claimed in claim 1, wherein the objective gathering module is configured to collect a plurality of objectives from the prompt, user role, configured usage and chain of thoughts based on which the objective of creating an optimized synthetic prompt is created.

6. The system as claimed in claim 1, wherein the prompt creation module helps in holistically optimized and privacy preserved prompts by rewriting the complete prompt based on the context gathering module, user role, configured usage, chain of thoughts and historic behaviour.

7. The system as claimed in claim 1, wherein the expected utility validation module while selecting the most optimal prompt may involve human in the loop based on configurable threshold parameters based on prompts'utility and level of risk identified.

8. The system as claimed in claim 1, wherein the prompt translation module may translate a prompt to a different language based on user preference or administrator preference or downstream model performance for various languages.

9. A method for conducting a prescriptive and protected prompt engineering for a generative artificial intelligence comprising:
characterized in that:
receiving, by a user requirement module of a processing subsystem, first queries prompt from a user as a user requirement;
collecting, by a context gathering module of the processing subsystem, an information related to a context of the input query;
collecting, by an objective collection module of the processing subsystem, a plurality of objectives of the one or more first input queries;
understanding, by a risk assessment and mitigation module of the processing subsystem, risk one or more input prompt related to a sensitive information and mitigation related to the one or more prompts for providing a holistically privacy optimized synthetic prompt generated with minimal identified risk;
generating, by a prompt creation module of the processing subsystem, the one or more holistically optimized and privacy preserved prompts by consideration of output of context gathering module and object gathering module;
suggesting, by an interactive query module of the processing subsystem, one or more second queries prompt to the user based on the user requirement to generate one or more prompts to allow the user to select and edit the one or more prompts;
validating, by an assumption validation module of the processing subsystem, the selected option of the plurality of options for the one or more prompts based on a plurality of predefined utility validation rules;
quantifying, by an expected utility validation module of the processing subsystem, the utility of the one or more generated optimized prompt with minimal risk as optimized by risk assessment and mitigation module and select the most optimal prompt; and
translating, by a prompt translation module of the processing subsystem, the selected prompt by the interactive query module based on a language preference of the user.
